(19) United States
(12) Patent Application Publication
(10) Pub. No.: US 2014/0137428 A1
(43) Pub. Date: May 22, 2014

(54) HEAT TREATMENT APPARATUS AND METHOD OF OBTAINING TONER

(71) Applicants: Kohji Takenaka, Toride-shi (JP); Yuichi Mizo, Toride-shi (JP); Hironori Minagawa, Moriya-shi (JP); Takakuni Kobori, Toride-shi (JP); Takeshi Ohtsu, Toride-shi (JP); Junichi Hagiwara, Tsuchiura-shi (JP); Daisuke Ito, Tsuchiura-shi (JP); Kunihiko Kawakita, Iga-shi (JP)

(72) Inventors: Kohji Takenaka, Toride-shi (JP); Yuichi Mizo, Toride-shi (JP); Hironori Minagawa, Moriya-shi (JP); Takakuni Kobori, Toride-shi (JP); Takeshi Ohtsu, Toride-shi (JP); Junichi Hagiwara, Tsuchiura-shi (JP); Daisuke Ito, Tsuchiura-shi (JP); Kunihiko Kawakita, Iga-shi (JP)

(73) Assignee: CANON KABUSHIKI KAISHA, Tokyo (JP)

(21) Appl. No.: 14/125,572

(22) PCT Filed: Jun. 7, 2012
(86) PCT No.: PCT/JP2012/065175

§ 371 Date: Dec. 11, 2013

(30) Foreign Application Priority Data
Jun. 13, 2011 (JP) 2011-130924

(51) Int. Cl. G03G 9/08; F26B 17/12; F26B 17/10

(52) U.S. Cl. CPC G03G 9/0815; F26B 17/103; F26B 17/124
USPC 34/505; 34/167; 34/168

(57) ABSTRACT

A heat treatment apparatus for heat-treating powder particles each containing a binder resin and a colorant includes: a powder particle supply unit (3); a hot air supply unit (2); a cold air supply unit (4); a regulating unit (6); and a collection unit (5). The apparatus is characterized in that: a protrusion with a height of 2 mm or more and 50 mm or less is provided in a region on a downstream side of the powder particle supply unit and on an upstream side of the cold air supply unit in an inner wall surface of the treatment chamber; and the heat treatment apparatus has a cross-section plane, which is perpendicular to a center axis of the treatment chamber and situated at the region where the protrusion is provided, and Dmin and Dmax satisfy the following relation 0.50≦Dmin/Dmax<1.0 where, Dmin represents a minimum value of the distance of a gap between the treatment chamber and the columnar member measured in the cross-section plane, and Dmax represents a maximum value of the distance of a gap between the treatment chamber and the columnar member measured in the cross-section plane.

### TECHNICAL FIELD

The present invention relates to a heat treatment apparatus for obtaining toner to be used in an image forming method such as an electrophotographic method, an electrostatic recording method, an electrostatic printing method, or a toner jet system recording method, and to a method of obtaining toner using the apparatus.

### BACKGROUND ART

In order to obtain toner with an appropriate circularity, there has been proposed a heat treatment apparatus for heat-treating pulverized toner to spheroidize the toner appropriately. However, in a conventional heat treatment apparatus, the quantity of heat which powder particles receive varies depending upon the position through which the powder particles pass, and hence it is difficult to heat-treat the powder particles uniformly.

In order to overcome the problem, a heat treatment apparatus has been proposed, in which a raw material supply portion is provided at the center of the apparatus, and a hot air supply portion is provided outside of the raw material supply portion (see Patent Literatures 1 and 2). Further, in order to heat-treat powder particles uniformly, an apparatus for heat treatment that heat-treats the powder particles by rotating an air stream inside the apparatus has also been proposed (see Patent Literature 3).

### CITATION LIST

### Patent Literature

PTL 1: Japanese Patent Application Laid-Open No. 2004
PTL 2: Japanese Patent Application Laid-Open No. 2004-276016
PTL 3: Japanese Examined Patent Publication No. H03-52858

### SUMMARY OF INVENTION

### Technical Problem

However, in the heat treatment apparatus described in Patent Literature 1, it is necessary to provide multiple raw material injection nozzles, which enlarges the apparatus. Further, a larger amount of compressed gas is required for supplying a raw material, which is not preferred in terms of production energy. In addition, in this apparatus, a raw material is injected linearly to annular hot air to thus cause a loss in a treatment part, which is inefficient for increasing a treatment amount.

Further, in the heat treatment apparatus described in Patent Literature 2, when a member inside the apparatus receives heat and stores heat, toner is fused to the member storing heat to thus prevent stable production of the toner, which is not preferred in terms of toner productivity in some cases.

Further, the inventors of the present invention have studied the heat treatment apparatus described in Patent Literature 3, and have confirmed that toner was not dispersed sufficiently and coarse particles were increased owing to the coalescence of the toner. Further, when a treatment amount was increased, the heat treatment efficiency of the toner decreased rapidly, and heat-treated toner and untreated toner were mixed. The reason for this is considered as follows: a powder particle input portion is provided inside a compressed gas supply portion, and the raw material toner is not dispersed so much inside the apparatus, and hence, instantaneous heat treatment is conducted in a narrow range.

It is an object of the present invention to provide an apparatus for heat-treating powder particles, for obtaining toner containing fewer coarse particles and having a sharp particle size distribution, and a method of obtaining toner using the apparatus. It is another object of the present invention to provide an apparatus for heat-treating powder particles, for obtaining toner having a circularity distribution within an appropriate range and having a sharp circularity distribution, and a method of obtaining toner using the apparatus.

### Solution to Problem

The present invention relates to an apparatus for heat-treating powder particles each containing a binder resin and a colorant, the heat treatment apparatus including:

(1) a treatment chamber having a cylindrical shape, in which the powder particles are heat-treated;
(2) a powder particle supply unit for supplying the powder particles to the treatment chamber;
(3) a hot air supply unit for heat-treating the supplied powder particles;
(4) a cold air supply unit for cooling the heat-treated powder particles;
(5) a regulating unit for regulating a flow of the supplied powder particles, the unit being provided in the treatment chamber; and
(6) a collection unit for collecting the heat-treated powder particles from a discharge port provided on the lower end part side of the treatment chamber, the heat treatment apparatus being characterized in that:
the regulating unit is a columnar member having a substantially circular cross-section, the member being placed on a center pole of the treatment chamber so as to protrude from the lower end part to the upper end part of the treatment chamber; the hot air supply unit is provided so that the hot air to be supplied is rotated along an inner wall of the treatment chamber;
the discharge port of the collection unit is provided in an outer circumferential portion of the treatment chamber so as to keep a rotation direction of the powder particles;
a protrusion with a height of 2 mm or more and 50 mm or less is provided in a region on a downstream side of the powder particle supply unit and on an upstream side of the cold air supply unit in an inner wall surface of the treatment chamber or in an outer wall surface of the regulating unit; and
the heat treatment apparatus has a cross-section plane, the cross-section plane
being perpendicular to a center axis of the treatment chamber, and situated at the region where the protrusion is provided, and Dmin and Dmax satisfy the following relation

0.50≦Dmin/Dmax<1.0

where,
Dmin represents a minimum value of the distance of a gap between the treatment chamber and the columnar member measured in the cross-section plane, and
Dmax represents a maximum value of the distance of a gap between the treatment chamber and the columnar member measured in the cross-section plane.

### Advantageous Effects of Invention

According to the present invention, it is possible to obtain toner containing fewer coarse particles due to coalescence and having a sharp particle size distribution. Further, it is possible to obtain toner having a circularity distribution within an appropriate range and having a sharp circularity distribution.

Further features of the present invention will become apparent from the following description of exemplary embodiments with reference to the attached drawings.

### BRIEF DESCRIPTION OF DRAWINGS

FIG. 1A is a perspective view illustrating an example of an outer appearance of a heat treatment apparatus of the present invention.

FIG. 1B is a perspective view illustrating an example of an inner structure of the heat treatment apparatus of the present invention.

FIGS. 2A, 2B, 2C, 2D, 2E, 2F, 2G, 2H, 2I, 2J, 2K and 2L are schematic partial cross-sectional views of the heat treatment apparatus used in examples and comparative examples. FIG. 2K is a partial enlarged view of FIG. 2G. FIG. 2L is a partial enlarged view of FIG. 2I.

### DESCRIPTION OF EMBODIMENTS

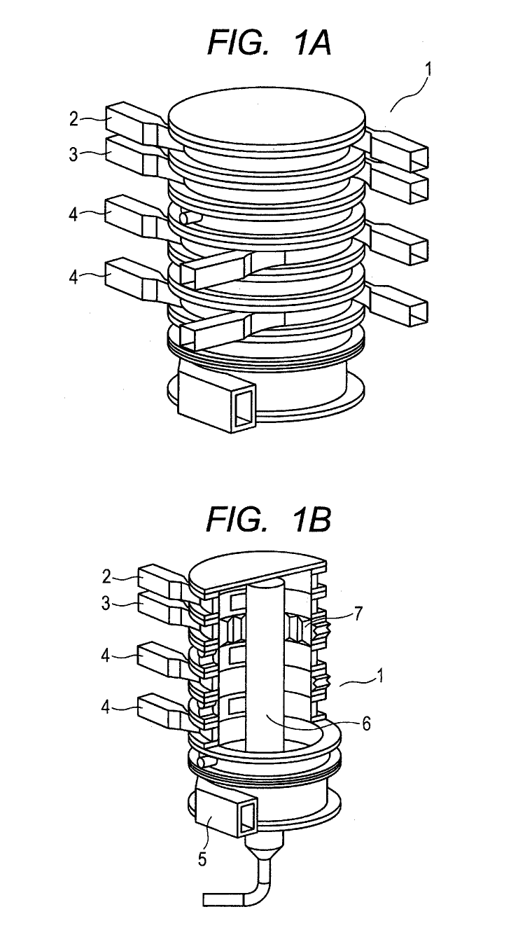

A heat treatment apparatus of the present invention is described. FIGS. 1A and 1B are views illustrating examples of the outer appearance and inner structure of an apparatus for heat-treating toner of the present invention, respectively.

In the heat treatment apparatus illustrated in FIGS. 1A and 1B, a treatment chamber for heat-treating powder particles in an apparatus body (1) has a cylindrical shape, and for example, a hot air supply unit (2) and a powder particle supply unit (3) are provided in this order from an upper side.

The hot air supply unit is shaped in such a manner as to rotate hot air to be supplied along an inner wall of the treatment chamber in the apparatus. For example, the hot air supply unit supplies hot air into the apparatus from a tangential direction with respect to a horizontal cross-section of the apparatus as illustrated in FIGS. 1A and 1B. Besides this construction, a system of regulating a flow of hot air with a member in a louver shape or a slit shape may be used.

Powder particles are conveyed by conveyance means such as compressed gas supplied from a compressed gas supply unit (not shown), and are supplied to the treatment chamber in the apparatus together with the conveying gas by the powder particle supply unit (3).

The powder particle supply unit (3) is constructed so as to supply the powder particles to the treatment chamber from the tangential direction with respect to the horizontal cross-section of the apparatus. That construction is preferred because the powder particles rotate smoothly in the treatment chamber without preventing a rotating flow of the hot air. Depending upon conditions such as the temperature and flow rate of the hot air, the supply amount of the powder particles, and the amount of the raw material-conveying gas, the powder particle supply unit may be placed in an upper stage and the hot air supply unit may be placed in a lower stage.

The heat-treated powder particles are cooled with cold air supplied from the cold air supply unit (4). The placement positions and number of the cold air supply units, and the temperature and air volume of the cold air are set freely so that the heat-treated powder particles are cooled sufficiently. The apparatus illustrated in FIGS. 1A and 1B has four cold air output portions in each of two stages, i.e., upper and lower stages so as to be capable of adjusting the air volume of each of the upper and lower stages independently. A member in a slit shape, a louver shape, or the like can be used for the cold air output portions. It is preferred that the cold air supply unit (4) be constructed so as to supply the cold air into the treatment chamber from the tangential direction with respect to the horizontal cross-section of the treatment chamber because the rotating flow in the treatment chamber becomes smooth.

Provided on the center pole of the treatment chamber is a regulating unit (6) that is a columnar member having a substantially circular cross-section and placed so as to protrude from a lower end part to an upper end part of the treatment chamber. Further, in the heat treatment apparatus illustrated in FIGS. 1A and 1B, there is provided a collection unit (5) for collecting powder particles from a discharge port provided in an outer circumferential portion and on the lower end part side of the treatment chamber so as to keep the rotation of the powder particles. By virtue of the placement of the regulating unit and the discharge port of the collection unit, the rotating flow in the apparatus can be kept smooth up to the lower end side of the apparatus. It is preferred that the regulating unit extend to the upper side of the powder particle supply unit because the powder particles can be supplied to the rotating flow (hot air) in an arranged state.

In the heat treatment apparatus of the present invention, the hot air supply unit is placed so as to supply hot air along the inner wall of the treatment chamber, the discharge port of the collection unit is provided in the outer circumferential portion in the lowermost part of the treatment chamber so as to keep the rotation direction of the hot air, and the substantially cylindrical regulating unit is provided on the center pole of the treatment chamber. Thus, the excellent dispersibility of the powder particles in the treatment chamber can be obtained, and the treatment amount per hour can be increased. A blower (not shown) is provided on the downstream side of the collection unit so that the powder particles that are cooled after being heat-treated are sucked and conveyed by the blower. Further, from the viewpoint of suppressing the adhesion of the powder particles to the apparatus, it is preferred that a cooling jacket be provided on the inner wall surface of the apparatus, the regulating unit, or the like, and the powder particles be cooled by any method such as the circulation of cooling water in the jacket.

The heat treatment apparatus of the present invention is characterized in that at least one protrusion is provided in a range on a downstream side of the powder particle supply unit and on an upstream side of the cold air supply unit in the inner wall surface of the treatment chamber or the outer wall surface of the regulating member. In addition, the protrusion has a height of 2 mm or more and 50 mm or less. Hereinafter, a region below the powder particle supply unit (3) and above the cold air supply unit (4) in the inner wall surface of the treatment chamber or the outer wall surface of the regulating member is referred to as a heat treatment zone. Further, the heat treatment apparatus of the present invention has a cross-section plane, which is perpendicular to a center axis of the treatment chamber and situated at the region where the protrusion is provided, and Dmin and Dmax satisfy the following relation

0.50≦Dmin/Dmax<1.0,

where, Dmin represents a minimum value of the distance of a gap between the treatment chamber and the columnar member measured in the cross-section plane, and Dmax represents a maximum value of the distance of a gap between the treatment chamber and the columnar member measured in the cross-section plane. The maximum value of the distance of the gap refers to a distance between the bottom of a concave portion and the wall surface or between the concave portions. On the other hand, the minimum value of the distance of the gap refers to the closest distance between the inner wall of the treatment chamber and the outer wall of the columnar member opposed to the inner wall, which is a distance between the tip end of the protrusion and the wall surface or between the protrusions. When the protrusions satisfy the condition, an air flow is agitated by the protrusions while the rotating flow is kept. Therefore, the powder particles in the air flow can be dispersed further satisfactorily and the temperature unevenness of the air flow can be eliminated. When the height of the protrusion is smaller than 2 mm, the function of agitating the powder particles becomes small. When the height of the protrusion is larger than 50 mm, the rotating flow is disturbed and the flow of the powder particles becomes stagnant, which inhibits the uniform heat treatment. Further, it is not preferred that the ratio (Dₘᵢₙ/Dₘₐₓ) be less than 0.50 because the rotating flow is disturbed.

The width of the heat treatment zone is preferably 200 to 600 mm, more preferably 300 to 450 mm. Further, although the protrusions may be formed over the entire width of the heat treatment zone, the protrusions may be formed in a part of the heat treatment zone.

Specifically, it is preferred that the protrusions cover a range of 100 mm or more.

The height of the protrusion is defined as described below. The distance from the center of the regulating member to the inner wall of the treatment chamber is measured in a radial direction in the cross-section perpendicular to the center axis of the treatment chamber in the heat treatment zone, and the maximum value thereof is defined as a reference radius.

Further, on the same cross-section, the distance from the center of the regulating member to the inner wall of the treatment chamber is measured in a radial direction, and the minimum value thereof is determined, and further, a difference between the reference radius and the minimum value is determined. This measurement is also conducted on any other cross-section in the heat treatment zone, and the maximum value of the obtained differences is set to be the height of the protrusion. In the case of a shape in which a concave is added to the heat treatment zone, the height is calculated, with the distance from the deepest point of the concave and the center of the regulating member being the reference radius.

Examples of the shape of the protrusion include a triangular shape, a barrel shape, a wave shape, and a dimple shape. Any shape may be used as long as the effects of the present invention can be obtained.

In the apparatus of FIGS. 1A and 1B, a freely replaceable heat treatment zone ring (7) is provided at the heat treatment zone. In the apparatus, the ring provides protrusions to the heat treatment zone. With this construction, the shape and size of the protrusion can be changed easily by replacing the heat treatment zone ring. The method of setting the protrusions is not limited to the method involving setting the ring as long as the effects of the present invention are obtained.

The powder particles to be treated in a heat treatment step generally have a particle size distribution. An inertial force and a centrifugal force are applied to the powder particles in a rotating flow flowing in the treatment chamber, and hence, the powder particles rotate on an outer circumferential side in the treatment chamber. At this time, particles each having a larger particle diameter are more influenced by an inertial force and a centrifugal force, and hence, the particles each having a larger particle diameter rotate on the further outer circumferential side in the heat treatment chamber as compared with the particles each having a small particle diameter.

Further, the powder particles are supplied into the apparatus together with conveying gas whose temperature is lower than that of hot air, and hence, the conveying gas containing the powder particles rotates on the outer circumferential side and the hot air excluded from the conveying gas rotates on the inner circumferential side. Thus, a heat gradient in a radial direction occurs in the apparatus.

More specifically, of the powder particles rotating in the treatment chamber, the fine particles rotating on the inner circumferential side come to receive heat from hot air more easily. The fine particles that have continuously received heat are melted excessively, and coalescence may occur owing to the collision between the toner particles. When the toner particles become particles each having a large particle diameter owing to the coalescence, a centrifugal force and an inertial force increase. Therefore, for example, the particles move to the outer circumferential side of a toner layer while being melted, thereby colliding with other powder particles to be further coalesced. Thus, the particles grow to coarse particles. On the other hand, relatively larger particles of the powder particles rotate on the outer circumference in the apparatus. Therefore, the relatively larger particles do not easily obtain a heat quantity required for spheroidization and are collected by the collection unit without the enhancement of their circularities.

According to the present invention, the phenomenon in which coalesced particles grow can be suppressed by providing protrusions to the heat treatment zone. For example, in the case where there are protrusions on the inner wall surface of the treatment chamber, an inertial force of a vector different from a tangential direction acts on relatively large particles which are largely influenced by an inertial force. Therefore, the proceeding direction changes from the outer circumferential tangential direction to the inner side direction of the treatment chamber or the like. Further, relatively small particles which are less influenced by an inertial force proceed together with an air stream along the shape of the protrusion by virtue of the resistance or Coanda effect of gas. More specifically, a force of moving to the inner circumferential side in the apparatus acts on the particles each having a large particle diameter by virtue of the protrusions in the apparatus, and a force of moving to the outer circumferential side acts on the particles each having a small particle diameter. Thus, the particle size distribution of the powder particles in the treatment chamber can be equalized.

In the case where the toner particles are not in an excess molten state, even when toner particles collide with each other, they do not coalesce. The growth of coarse particles by coalescence can be suppressed by disturbing the particle size distribution of a toner layer before fine particles receive excess heat to be melted excessively. Further, the generation of the particles in a substantially spherical state generated by the reception of excess heat can also be suppressed. The large particles to which heat has not been applied easily so far can be provided with an appropriate heat quantity, and hence, the circularities of the large particles can be enhanced. Further, by adjusting conditions such as the size of the protrusion and the flow velocity of the rotating flow appropriately, the circularity distribution of the powder particles after heat treatment can be adjusted to any distribution.

In the end, the large particles return to the outer circumferential side by virtue of a centrifugal force to form an original particle size distribution again after the disturbance of the particle size distribution by the protrusions. Therefore, it is preferred that the heat treatment apparatus be provided with at least two protrusions, and further, multiple protrusions be provided in a repeated manner.

Further, by largely disturbing the distribution of powder particles with relatively large protrusions, the mixing of conveying gas and hot air can be accelerated, and the efficiency of heat treatment can be enhanced. Thus, the temperature of the hot air can be lowered and the heat treatment apparatus can be reduced in size. Further, a supplementary facility such as a hot air generating device can also be reduced in size, and the production energy can also be reduced.

In the case where the height of the protrusion provided on the inner surface of the apparatus is small, the disturbance is applied only to the relatively large particles in the powder particles. The particles each having a small particle diameter come to be influenced by the disturbance as the height of the protrusion increases. More specifically, the circularity distribution or the like of the powder particles after heat treatment can be set to be a desired one by adjusting the height of the protrusion. When the protrusion becomes larger, the mixing between hot air and toner-conveying gas is accelerated.

The optimum height of the protrusion is appropriately determined depending upon the apparatus size, the wind velocity of the rotating flow, the physical properties of toner to be required, etc.

In the present invention, the protrusion may be provided at a position outside of the heat treatment zone as long as the effects of the present invention are not impaired.

It is preferred that the protrusion be also provided below the cold air supply unit in addition to those in the heat treatment zone because the powder particles can be cooled rapidly, and the mixing of cold air and hot air is accelerated to enhance the cooling efficiency, which enables, for example, a reduction in size of the cold air generating device.

Further, it is preferred that multiple protrusions be present continuously, and the repetition distance between a protrusion and an adjacent protrusion be 20 mm or more and 200 mm or less because the powder particles can be disturbed repeatedly. At this time, the repetition distance refers to a distance in a circumferential direction between adjacent protrusions (circumferential distance on a circumference based on a reference radius).

Next, a procedure of obtaining toner through use of the heat treatment apparatus of the present invention is described.

First, in a raw material mixing step, as raw materials for toner, at least a resin and a colorant are weighed in predetermined amounts and mixed with each other. As a mixing apparatus, there are given, for example, a Henschel mixer (manufactured by NIPPON COKE & ENGINEERING CO., LTD.), a Super Mixer (manufactured by KAWATA MFG Co., Ltd.), a Ribocone (manufactured by OKAWARA CORPORATION), a Nauta Mixer, a Turburizer, and a Cyclomix (manufactured by Hosokawa Micron Corporation), a Spiral Pin Mixer (manufactured by Pacific Machinery & Engineering Co., Ltd.), and a Loedige Mixer (manufactured by MATSUBO Corporation).

Further, in a melt-kneading step, the mixed raw materials for toner are melt-kneaded to melt the resins and disperse the colorant or the like in the raw materials. As a kneading apparatus, there are given, for example, a TEM-type extruder (manufactured by TOSHIBA MACHINE Co., Ltd.), a TEX Biaxial Kneader (manufactured by The Japan Steel Works, Ltd.), a PCM Kneader (manufactured by Ikegai Corp.), and a Kneadex (manufactured by Mitsui Mining Co., Ltd.). A continuous kneader such as a monoaxial or biaxial extruder is preferred to a batch type kneader because the continuous kneader has an advantage such as being applicable to continuous production.

Further, a colored resin composition obtained by melt-kneading the raw materials for toner is rolled with a twin roll or the like after the melt-kneading and cooled through a cooling step of cooling with water or the like.

The cooled product of the colored resin composition obtained in the foregoing is then pulverized into particles each having a desired particle diameter in a pulverization step. In the pulverization step, first, the cooled product is roughly pulverized with a crusher, a hammer mill, a feather mill, or the like, and then finely pulverized with a Kryptron System (manufactured by Kawasaki Heavy Industries Inc.), a Super Rotor (manufactured by Nisshin Engineering Inc.), or the like. Thus, toner fine particles are obtained.

The toner fine particles thus obtained are classified into toner powder particles each having a desired particle diameter in a classification step. As a classifier, there are given, for example, a Turboplex, a Faculty, a TSP separator, and a TTSP separator (manufactured by Hosokawa Micron Corporation), and an Elbow-Jet (manufactured by Nittetsu Mining Co., Ltd.).

Then, the obtained toner powder particles are spheroidized through use of the heat treatment apparatus of the present invention in a heat treatment step.

According to the method of obtaining toner of the present invention, inorganic fine particles and the like may be added, if required, to the obtained toner powder particles before the heat treatment step.

Available as a method of adding inorganic fine particles and the like to the toner powder particles is a method involving: compounding the toner powder particles and known various kinds of external additives in predetermined amounts; and agitating and mixing the compounded particles through use of a high-speed agitator which provides a shear force to powder, such as a Henschel mixer, a Mechanohybrid (manufactured by NIPPON COKE & ENGINEERING CO., LTD.), a super mixer, or a NOBILTA (manufactured by Hosokawa Micron Corporation) as an external adding device.

According to the method of obtaining toner of the present invention, an inorganic fine powder is added to the toner powder particles before the heat treatment step. Thus, the powder particles are provided with flowability, and the powder particles introduced to the treatment chamber can be dispersed more equally to come into contact with hot air, and toner excellent in uniformity can be obtained.

According to the method of obtaining toner of the present invention, in the case where coarse particles are present after heat treatment, if required, the step of removing coarse particles by classification may be provided. Examples of a classifier for removing coarse particles include: a Turboplex, a TSP separator, and a TTSP separator (manufactured by Hosokawa Micron Corporation); and an Elbow-Jet (manufactured by Nittetsu Mining Co., Ltd.).

Further, after the heat treatment, a sieving machine such as: an Ultra Sonic (manufactured by Koei Sangyo Co., Ltd.); a Rezona Sieve or a Gyro Sifter (manufactured by Tokuju Corporation); a Turbo Screener (manufactured by Turbo Kogyo Co., Ltd.); or a HI-VOLTA (manufactured by TOYO HITEC Co., Ltd.) may be used for sieving coarse particles and the like, if required.

It should be noted that the heat treatment step of the present invention may be performed after the fine pulverization, or may be performed after the classification.

Next, a preferred construction of toner for achieving the object of the present invention is described in detail below.

Examples of the binder resin include a vinyl-based resin, a polyester-based resin, and an epoxy resin. Of those, the vinyl-based resin and the polyester-based resin are more preferred in terms of chargeability and fixability. In particular, in the case of using the polyester-based resin, an effect of the introduction of the apparatus is large.

In addition, the binder resin may be mixed with a homopolymer or copolymer of a vinyl-based monomer, polyester, polyurethane, an epoxy resin, polyvinyl butyral, rosin, modified rosin, a terpene resin, a phenol resin, an aliphatic or alicyclic hydrocarbon resin, an aromatic petroleum resin, or the like before use, if required.

In the case where at least two kinds of resins are mixed to be used as the binder resin, it is preferred that resins having different molecular weights be mixed at an appropriate mixing ratio.

The glass transition temperature of the binder resin is preferably 45 to 80° C., more preferably 55 to 70° C., the number average molecular weight (Mn) thereof is preferably 2,500 to 50,000, and the weight average molecular weight (Mw) thereof is preferably 10,000 to 1,000,000.

As the binder resin, a polyester resin described below is preferred.

It is preferred that the polyester resin contain 45 to 55 mol % of an alcohol component among all the components in its raw material monomers.

The acid value of the polyester resin is preferably 90 mgKOH/g or less, more preferably 50 mgKOH/g or less, and the hydroxyl value thereof is preferably 50 mgKOH/g or less, more preferably 30 mgKOH/g or less. This is because a charging characteristic of the toner is more dependent on an environment as the number of terminal groups on a molecular chain increases.

The glass transition temperature of the polyester resin is preferably 50 to 75° C., more preferably 55 to 65° C., the number average molecular weight (Mn) thereof is preferably 1,500 to 50,000, more preferably 2,000 to 20,000, and the weight average molecular weight (Mw) thereof is preferably 6,000 to 100,000, more preferably 10,000 to 90,000.

When the toner is used as magnetic toner, as a magnetic material contained in the magnetic toner, there are given, for example, iron oxides such as magnetite, maghemite, and ferrite, and other iron oxides containing metal oxides, metals such as Fe, Co, and Ni, or alloys of the metals with metals such as Al, Co, Cu, Pb, Mg, Ni, Sn, Zn, Sb, Be, Bi, Cd, Ca, Mn, Se, Ti, W, and V, and mixtures thereof.

Specific examples of the magnetic material include triiron tetraoxide (Fe₃O₄), iron sesquioxide (γ-Fe₂O₃), zinc iron oxide (ZnFe₂O₄), yttrium iron oxide (Y₃Fe₅O₁₂), cadmium iron oxide (CdFe₂O₄), gadolinium iron oxide (Gd₃Fe₅O₁₂), copper iron oxide (CuFe₂O₄), lead iron oxide (PbFe₁₂O₁₉), nickel iron oxide (NiFe₂O₄), neodymium iron oxide (NdFe₂O₃), barium iron oxide (BaFe₁₂O₁₉), magnesium iron oxide (MgFe₂O₄), manganese iron oxide (MnFe₂O₄), lanthanum iron oxide (LaFeO₃), an iron powder (Fe), a cobalt powder (Co), and a nickel powder (Ni). One kind of the magnetic materials is used alone, or two or more kinds thereof are used in combination. A particularly suitable magnetic material is a fine powder of triiron tetraoxide or γ-iron sesquioxide.

The magnetic material is used in an amount of preferably 20 to 150 parts by mass, more preferably 50 to 130 parts by mass, still more preferably 60 to 120 parts by mass with respect to 100 parts by mass of the binder resin.

A non-magnetic colorant includes the following.

A black colorant includes the following: carbon black; and a colorant adjusted to a black color by using a yellow colorant, a magenta colorant, and a cyan colorant.

A coloring pigment for magenta toner includes the following: a condensed azo compound, a diketopyrrolopyrrole compound, anthraquinone, a quinacridone compound, a basic dye lake compound, a naphthol compound, a benzimidazolone compound, a thioindigo compound, and a perylene compound. Specific examples thereof include: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 144, 146, 150, 163, 166, 169, 177, 184, 185, 202, 206, 207, 209, 220, 221, 238, 254, or 269; C.I. Pigment Violet 19; and C.I. Vat Red 1, 2, 10, 13, 15, 23, 29, or 35.

In the colorant, a pigment may be used alone. However, it is preferred that a dye and a pigment be used in combination to improve the color definition of the colorant from the viewpoint of increasing the image quality of a full color image.

A dye for magenta toner includes the following: oil-soluble dyes such as C.I. Solvent Red 1, 3, 8, 23, 24, 25, 27, 30, 49, 81, 82, 83, 84, 100, 109, or 121, C.I. Disperse Red 9, C.I. Solvent Violet 8, 13, 14, 21, or 27, and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, or 40, and C.I. Basic Violet 1, 3, 7, 10, 14, 15, 21, 25, 26, 27, or 28.

A coloring pigment for cyan toner includes the following: C.I. Pigment Blue 1, 2, 3, 7, 15:2, 15:3, 15:4, 16, 17, 60, 62, or 66; C.I. Vat Blue 6; C.I. Acid Blue 45; and a copper phthalocyanine pigment having a phthalocyanine skeleton with 1 to 5 phthalimidomethyl substituents.

A coloring pigment for yellow toner includes the following: a condensed azo compound, an isoindolinone compound, an anthraquinone compound, an azo metallic compound, a methine compound, and an allylamide compound. Specific examples thereof include: C.I. Pigment Yellow 1, 2, 3, 4, 5, 6, 7, 10, 11, 12, 13, 14, 15, 16, 17, 23, 62, 65, 73, 74, 83, 93, 95, 97, 109, 110, 111, 120, 127, 128, 129, 147, 155, 168, 174, 180, 181, 185, or 191; and C.I. Vat Yellow 1, 3, or 20. Further, dyes such as C.I. Direct Green 6, C.I. Basic Green 4, C.I. Basic Green 6, and C.I. Solvent Yellow 162 may be used.

Further, in the obtaining toner, it is preferred to use a master batch formed by mixing a colorant with a binder resin in advance. Then, the colorant master batch and other raw materials (such as a binder resin and a wax) can be melt-kneaded to disperse the colorant in toner satisfactorily.

In the case of mixing a colorant with a binder resin to form a master batch, the dispersibility of the colorant is not degraded even when the colorant is used in a large amount, and the dispersibility of the colorant in toner particles is improved. Consequently, color reproducibility such as color mixture property or transparency becomes excellent. Further, toner having a large covering power on a transfer material can be obtained. Further, by virtue of the improvement of the dispersibility of the colorant, the endurance stability of the chargeability of the toner becomes excellent, and an image keeping high image quality can be obtained.

The colorant is used in an amount of preferably 0.1 to 30 parts by mass, more preferably 0.5 to 20 parts by mass, particularly preferably 3 to 15 parts by mass with respect to 100 parts by mass of the binder resin.

A charge control agent can be used in the toner, if required, so as to additionally stabilize its chargeability. It is preferred that the charge control agent be used in an amount of 0.5 to 10 parts by mass with respect to 100 parts by mass of the binder resin.

The charge control agent includes the following.

As a negative charge control agent for controlling the toner so that the toner is negatively chargeable, for example, an organometallic complex or a chelate compound is effective, and examples thereof include a monoazo metal complex, an aromatic hydroxycarboxylic acid metal complex, and an aromatic dicarboxylic acid-based metal complex. Further examples thereof include an aromatic hydroxycarboxylic acid, aromatic mono- and polycarboxylic acids and metal salts thereof, anhydrides thereof, or esters thereof, and a phenol derivative of bisphenol.

As a positive charge control agent for controlling the toner so that the toner is positively chargeable, there are given, for example, nigrosine and denatured products thereof with fatty acid metal salts and the like, quaternary ammonium salts such as tributylbenzylammonium-1-hydroxy-4-naphthosulfonate and tetrabutylammonium tetrafluoroborate, onium salts such as phosphonium salts as analogs of the quaternary ammonium salts, triphenylmethane dyes as chelate pigments of the salts, lake pigments thereof (lake agents include phosphotungstic acid, phosphomolybdic acid, phosphotungsten molybdic acid, tannic acid, lauric acid, gallic acid, ferricyanic acid, and a ferrocyanide), and metal salts of higher fatty acids including diorganotin oxides such as dibutyltin oxide, dioctyltin oxide, and dicyclohexyltin oxide, and diorganotin borates such as dibutyltin borate, dioctyltin borate, and dicyclohexyltin borate.

One or two or more kinds of mold releasing agents may be incorporated into the toner particles as needed. Examples of the mold releasing agents include the following.

The examples include: aliphatic hydrocarbon-based waxes such as low-molecular weight polyethylene, low-molecular weight polypropylene, a microcrystalline wax, and a paraffin wax, and oxides of the aliphatic hydrocarbon-based waxes such as a polyethylene oxide wax or block copolymers thereof; waxes mainly including fatty acid esters such as a carnauba wax, a Sasol wax, and a montanic acid ester wax; and partially or wholly deacidified fatty acid esters such as a deacidified carnauba wax. The examples further include: saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; long-chain alkyl alcohols; polyhydric alcohols such as sorbitol; fatty acid amides such as linoleic acid amide, oleic acid amide, and lauric acid amide; saturated fatty acid bisamides such as methylenebis(stearic acid amide), ethylenebis(capric acid amide), ethylenebis(lauric acid amide), and hexamethylenebis(stearic acid amide); unsaturated fatty acid amides such as ethylenebis(oleic acid amide), hexamethylenebis(oleic acid amide), N,N′-dioleyl adipic acid amide, and N,N-dioleyl sebacic acid amide; aromatic bisamides such as m-xylenebis(stearic acid amide) and N,N-distearyl isophthalic acid amide; fatty acid metal salts (generally referred to as metallic soaps) such as calcium stearate, calcium laurate, zinc stearate, and magnesium stearate; waxes obtained by grafting aliphatic hydrocarbon-based waxes with vinyl-based monomers such as styrene and acrylic acid; partially esterified compounds of fatty acids and polyhydric alcohols such as behenic monoglyceride; and methyl ester compounds each having a hydroxyl group obtained by the hydrogenation of vegetable fats and oils.

The amount of the mold releasing agent is preferably 0.1 to 20 parts by mass, more preferably 0.5 to 10 parts by mass with respect to 100 parts by mass of the binder resin.

Further, the melting point of the mold releasing agent defined by a maximum endothermic peak temperature at the time of temperature rise measured with a differential scanning calorimeter (DSC) is preferably 65 to 130° C., more preferably 80 to 125° C.

The toner is preferably such that a fine powder is externally added as a flowability improver to the toner particles. Particularly preferred examples thereof include: fluorine-based resin powders such as a vinylidene fluoride fine powder and a polytetrafluoroethylene fine powder; and a product obtained by subjecting a silica fine powder such as wet silica or dry silica, a titanium oxide fine powder, an alumina fine powder, or the like to a hydrophobizing treatment by treating its surface with a silane coupling agent, a titanium coupling agent, or silicone oil, the product being treated to show a hydrophobicity value in a range of 30 to 80 measured by methanol titration test.

The fluidizer has a specific surface of preferably 30 m²/g or more, more preferably 50 m²/g or more by nitrogen adsorption measured by the BET method.

An inorganic fine powder except those described above may be added to the toner so that the powder imparts chargeability and flowability in addition to a polishing effect or serves as a cleaning aid. When the inorganic fine powder is externally added to the toner particles, an improved effect can be obtained after the addition as compared with that before the addition. Examples of the inorganic fine powder include titanates and/or silicates of magnesium, zinc, cobalt, manganese, strontium, cerium, calcium, and barium.

The inorganic fine particles are used in an amount of preferably 0.1 to 10 parts by mass, more preferably 0.2 to 8 parts by mass with respect to 100 parts by mass of the toner particles.

Although the toner can also be used as a magnetic one-component developer or a non-magnetic one-component developer, the toner can also be mixed with a carrier for use as a two-component developer.

Examples of the magnetic carrier include generally known carriers such as: an iron powder whose surface is oxidized or an unoxidized iron powder; particles of metals such as iron, lithium, calcium, magnesium, nickel, copper, zinc, cobalt, manganese, chromium, and rare earths, and particles of alloys thereof; oxide particles; magnetic materials such as ferrite; and a magnetic material-dispersed resin carrier (so-called resin carrier) containing a magnetic material and a binder resin holding the magnetic material in a state of being dispersed therein.

When the toner is mixed with the magnetic carrier so as to be used as a two-component developer, the concentration of the toner in the developer is preferably 2 mass % or more and 15 mass % or less, more preferably 4 mass % or more and 13 mass % or less. It is preferred that the weight average particle diameter (D4) of toner particles obtained through treatment with the heat treatment apparatus of the present invention be 4 μm or more and 12 μm or less.

Measuring methods for various physical properties of the toner are described below.

<Method of measuring weight average particle diameter (D4)> The weight average particle diameter (D4) of the toner was measured with the number of effective measurement channels of 25,000 by using a precision particle size distribution measuring apparatus based on a pore electrical resistance method provided with a 100-μm aperture tube “Coulter Counter Multisizer 3” (trade name; manufactured by Beckman Coulter, Inc.) and dedicated software included therewith “Beckman Coulter Multisizer 3 Version 3.51” (manufactured by Beckman Coulter, Inc.) for setting measurement conditions and analyzing measurement data. Then, the measurement data was analyzed to calculate the diameter.

An electrolyte solution prepared by dissolving reagent grade sodium chloride in ion-exchanged water so as to have a concentration of about 1 mass %, for example, an “ISOTON II” (manufactured by Beckman Coulter, Inc.) can be used in the measurement.

It should be noted that the dedicated software is set as described below prior to the measurement and the analysis.

In the “change standard measurement method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc.) is set as a Kd value. A threshold and a noise level are automatically set by pressing a threshold/noise level measurement button. In addition, a current is set to 1,600 μA, a gain is set to 2, and an electrolyte solution is set to an ISOTON II, and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256, and a particle diameter range is set to the range of 2 μm to 60 μm.

A specific measurement method is as described below.

(1) About 200 ml of the electrolyte solution are charged into a 250-ml round-bottom beaker made of glass dedicated for the Multisizer 3. The beaker is set in a sample stand, and the electrolyte solution in the beaker is stirred with a stirrer rod at 24 rotations/sec in a counterclockwise direction. Then, dirt and bubbles in the aperture tube are removed by the “aperture flush” function of the dedicated software.
(2) About 30 ml of the electrolyte solution are charged into a 100-ml flat-bottom beaker made of glass. About 0.3 ml of a diluted solution prepared by diluting a “Contaminon N” (a 10-mass % aqueous solution of a neutral detergent for washing a precision measuring device formed of a nonionic surfactant, an anionic surfactant, and an organic builder and having a pH of 7 manufactured by Wako Pure Chemical Industries, Ltd.) with ion-exchanged water by three parts by mass fold is added as a dispersant to the electrolyte solution.
(3) An ultrasonic dispersing unit “Ultrasonic Dispersion System Tetora 150” (manufactured by Nikkaki Bios Co., Ltd.) in which two oscillators each having an oscillatory frequency of 50 kHz are built so as to be out of phase by 180° and which has an electrical output of 120 W is prepared. A predetermined amount of ion-exchanged water is charged into the water tank of the ultrasonic dispersing unit. About 2 ml of the Contaminon N are charged into the water tank.
(4) The beaker in the section (2) is set in the beaker fixing hole of the ultrasonic dispersing unit, and the ultrasonic dispersing unit is operated. Then, the height position of the beaker is adjusted so that the liquid level of the electrolyte solution in the beaker may resonate with an ultrasonic wave from the ultrasonic dispersing unit to the fullest extent possible.
(5) About 10 mg of toner are gradually added to and dispersed in the electrolyte solution in the beaker in the section (4) in a state in which the electrolyte solution is irradiated with the ultrasonic wave. Then, the ultrasonic dispersion treatment is continued for an additional 60 seconds. It should be noted that the temperature of water in the water tank is appropriately adjusted so as to be 10° C. or more and 40° C. or less upon ultrasonic dispersion.
(6) The electrolyte solution in the section (5) in which the toner has been dispersed is dropped with a pipette to the round-bottom beaker in the section (1) placed in the sample stand, and the concentration of the toner to be measured is adjusted to about 5%. Then, measurement is performed until the number of measured particles reaches 50,000.
(7) The measurement data is analyzed with the dedicated software included with the apparatus, and the weight average particle diameter (D4) is calculated. It should be noted that an “average diameter” on the “analysis/volume statistics (arithmetic average)” screen of the dedicated software when the dedicated software is set to “graph/vol %” is the weight average particle diameter (D4).

<Method of calculating coarse powder amount> A coarse powder amount (vol %) on a volume basis in the toner or the powder particles is calculated as described below.

For example, when particles each having a particle diameter 1.5 or more times as large as the weight average particle diameter of the toner are regarded as a coarse powder, after the measurement with the Multisizer 3 has been performed, (1) the chart for the results of the measurement is displayed in terms of vol % by setting the dedicated software to “graph/vol %,” and (2) “>” of the particle diameter-setting portion in the “format/particle diameter/particle diameter statistics” screen is checked, and a value (a) obtained by multiplying the weight average particle diameter by 1.5 is input in the particle diameter-inputting portion below the particle diameter-setting portion. Then, (3) the numerical value in the “>(a) μm” display portion when the “analysis/volume statistic (arithmetic average)” screen is displayed is the vol % of the particles each having a particle diameter 1.5 or more times as large as the weight average particle diameter of the toner.

Measurement of average circularity of toner particles and average circularity limited to coarse powder> The average circularity of the toner or the powder particles is measured under measurement and analysis conditions at the time of a calibration operation with a flow-type particle image analyzer “FPIA-3000” (manufactured by SYSMEX CORPORATION).

A specific measurement method is as described below. Added to 20 ml of ion-exchanged water are a suitable amount of a surfactant as a dispersant, preferably an alkylbenzene sulfonate, and then 0.02 g of a measurement sample. The mixture is subjected to a dispersion treatment for 2 minutes using a desktop ultrasonic cleaning and dispersing unit having an oscillatory frequency of 50 kHz and an electrical output of 150 W (for example, a “VS-150” (manufactured by VELVO-CLEAR). Thus, a dispersion liquid for measurement is obtained. At that time, the dispersion liquid is appropriately cooled so as to have a temperature of 10° C. or more and 40° C. or less.

The flow-type particle image analyzer mounted with a regular objective lens (magnification: 10) is used in the measurement, and a particle sheath “PSE-900A” (manufactured by SYSMEX CORPORATION) is used as a sheath liquid. The dispersion liquid prepared in accordance with the procedure is introduced into the flow-type particle image analyzer, and 3,000 toner particles are subjected to measurement according to the total count mode of an HPF measurement mode. Then, the average circularity of the toner or the powder particles is determined with a binarization threshold at the time of particle analysis set to 85% and particle diameters to be analyzed limited to ones each corresponding to an equivalent circle diameter of 2.00 μm or more and 200.00 μm or less.

Further, the particle diameters to be analyzed are limited to the (a) μm, which is 1.5 times as large as the weight average particle diameter determined with the Multisizer 3, or more and 200.00 μm or less, and an average circularity limited to a coarse powder is determined.

On the measurement, automatic focusing is performed with standard latex particles (obtained by diluting, for example, 5200A manufactured by Duke Scientific with ion-exchanged water) prior to the initiation of the measurement. After that, focusing is preferably performed every two hours from the initiation of the measurement.

It should be noted that in each example of the present application, a flow-type particle image analyzer which had been subjected to a calibration operation by SYSMEX CORPORATION and received a calibration certificate issued by SYSMEX CORPORATION was used. The measurement was performed under measurement and analysis conditions identical to those at the time of the reception of the calibration certificate except that particle diameters to be analyzed were limited to ones each corresponding to an equivalent circle diameter of 2.00 μm or more and 200.00 μm or less, or to the (a) μm or more and 200.00 μm or less.

(Production of toner particles A) Binder resin (polyester resin): 100 parts by mass
(Tg: 57.5° C., acid value: 25 mgKOH/g, hydroxyl value: 20 mgKOH/g, molecular weight: Mp 5,450, Mn 2,800, Mw 49,000)
C.I. Pigment Blue 15:3:5 parts by mass Aluminum 1,4-di-t-butylsalicylate compound: 0.5 part by mass
Fischer-Tropsch wax: 5 parts by mass (manufactured by Nippon Seiro Co., Ltd., product name: FT-100, melting point: 98° C.)

The materials of the foregoing prescription were mixed well with a Henschel mixer (FM-75J type manufactured by Mitsui Mining Co., Ltd.) and then kneaded with a biaxial kneader (PCM-30 type manufactured by Ikegai Corp.) set at a temperature of 130° C. at a feed amount of 10 kg/hr (the temperature of the kneaded product at the time of its ejection was about 150° C.). The obtained kneaded product was cooled and roughly pulverized with a hammer mill and then finely pulverized with a mechanical pulverizer (T-250: manufactured by Turbo Kogyo Co., Ltd.) at a feed amount of 15 kg/hr. Thus, a finely pulverized toner B-1 was obtained, which had a weight average particle diameter of 6.6 μm, and contained particles each having a particle diameter of 4.0 μm or less at 42.6 number % and particles (coarse powder) each having a particle diameter of at least 9.9 μm, which was 1.5 times as large as the weight average particle diameter, at 2.8 vol %.

The obtained finely pulverized toner B-1 was subjected to classification for cutting off a fine powder and a coarse powder with a rotary classifier (TTSP100 manufactured by Hosokawa Micron Corporation) at a feed amount of 4.2 kg/hr. Thus, toner particles A were obtained, which had a weight average particle diameter of 6.8 μm, and contained particles each having a particle diameter of 4.0 μm or less at 19.4 number % and particles each having a particle diameter of at least 10.2 μm, which was 1.5 times as large as the weight average particle diameter, at 2.6 vol %.

The toner particles A were measured for their circularities with an FPIA-3000. As a result, the content of particles having an average circularity of 0.943 and each having a particle diameter of 2 μm or less was 6.2%. Further, the circularity of a coarse powder having a particle diameter of 10.2 μm or more was 0.925.

(Production of Toner Treated Particles)

The following materials were placed in a Henschel mixer (FM-75, manufactured by NIPPON COKE & ENGINEERING CO., LTD.) and mixed at a circumferential velocity of rotary vanes of 50.0 m/s for a mixing time of 5 minutes. Thus, toner treated particles A1 in which silica and titanium oxide were caused to adhere to the surfaces of the toner particles A were obtained.

Toner particles A: 100 parts by mass
Silica: 3.0 parts by mass
(obtained by subjecting silica fine particles formed by a sol-gel method to surface treatment with 1.5 mass % of hexamethyldisilazane and adjusting the particle size distribution of the silica fine particles to a desired one by classification)
Titanium oxide: 0.5 part by mass
(obtained by subjecting metatitanic acid having anatase crystallinity to surface treatment)

### Example 1 of a Heat Treatment Zone Ring

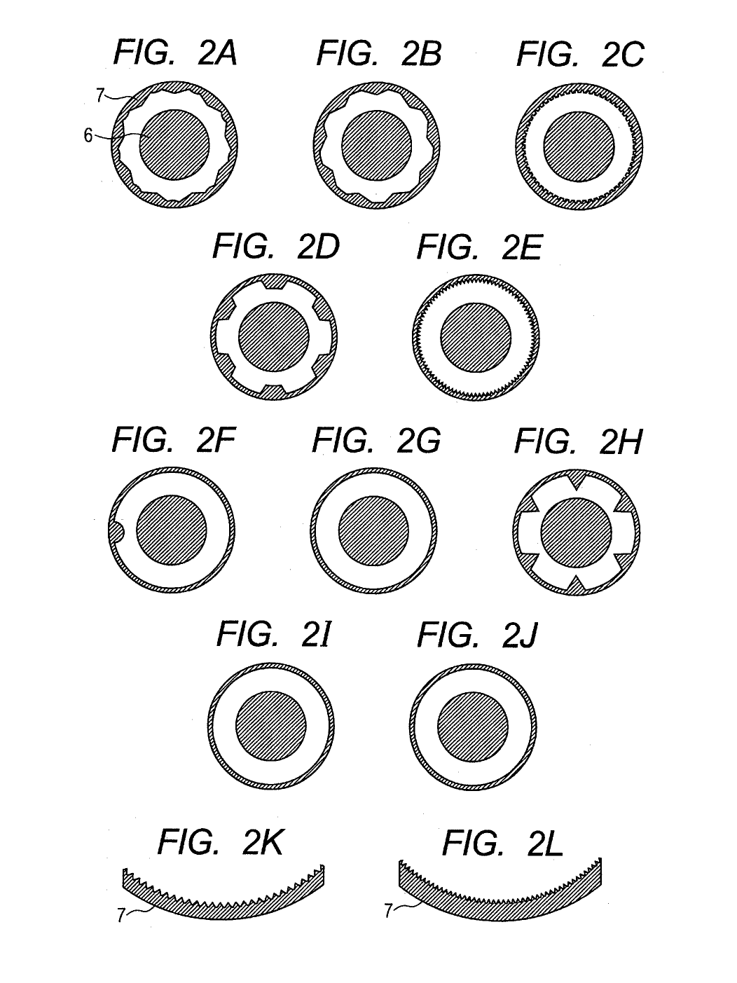

A ring obtained by combining 9 triangle protrusions each having a height of 20 mm and a length of 200 mm, and 9 semi-circular dents each having a depth of 5 mm and a length of 200 mm with a cylindrical ring having an inner diameter (diameter) of 500 mm and a height of 300 mm as a base was defined as a ring A. The repetition distances on the circumference of the protrusions were a combination of three kinds: 159 mm, 174.5 mm, and 190 mm. FIG. 2A illustrates a schematic cross-sectional view of the ring A and the regulating unit.

### Example 2 of a Heat Treatment Zone Ring

A ring obtained by providing 9 triangle protrusions each having a height of 20 mm and a length of 200 mm at an equal interval to a cylindrical ring having an inner diameter (diameter) of 500 mm and a height of 300 mm as a base was defined as a ring B. The repetition distance on the circumference of the protrusions was 174.5 mm. FIG. 2B illustrates a schematic cross-sectional view of the ring B and the regulating unit.

### Example 3 of a Heat Treatment Zone Ring

A ring obtained by providing 60 round protrusions each having a height of 10 mm and a length of 200 mm at an equal interval to a cylindrical ring having an inner diameter (diameter) of 500 mm and a height of 300 mm as a base was defined as a ring C. The repetition distance on the circumference of the protrusions was 26.2 mm. FIG. 2C illustrates a schematic cross-sectional view of the ring C and the regulating unit.

### Example 4 of a Heat Treatment Zone Ring

A ring obtained by providing 6 trapezoid protrusions each having a height of 35 mm and a length of 200 mm at an equal interval to a cylindrical ring having an inner diameter (diameter) of 500 mm and a height of 300 mm as a base was defined as a ring D. The repetition distance on the circumference of the protrusions was 261.8 mm. FIG. 2D illustrates a schematic cross-sectional view of the ring D and the regulating unit.

### Example 5 of a Heat Treatment Zone Ring

A ring obtained by laying 90 semi-circular dimples each having a depth of 5 mm at an equal interval on the circumference of the inner surface of a cylindrical ring having an inner diameter (diameter) of 500 mm and a height of 300 mm as a base was defined as a ring E. The repetition distance of the concave portions was 17.5 mm. FIG. 2E illustrates a schematic cross-sectional view of the ring E and the regulating unit.

### Example 6 of a Heat Treatment Zone Ring

A ring obtained by providing only 1 semi-circular protrusion having a height of 45 mm and a length of 200 mm to a cylindrical ring having an inner diameter (diameter) of 500 mm and a height of 300 mm as a base was defined as a ring F. FIG. 2F illustrates a schematic cross-sectional view of the ring F and the regulating unit.

### Example 7 of a Heat Treatment Zone Ring

A ring obtained by providing 180 triangle protrusions each having a height of 2.5 mm and a length of 200 mm at an equal interval to a cylindrical ring having an inner diameter (diameter) of 500 mm and a height of 300 mm as a base was defined as a ring G. The repetition distance on the circumference of the protrusions was 8.7 mm. FIG. 2G illustrates a schematic cross-sectional view of the ring G and the regulating unit.

### Example 8 of a Heat Treatment Zone Ring

A ring obtained by providing 6 triangle protrusions each having a height of 60 mm and a length of 200 mm at an equal interval to a cylindrical ring having an inner diameter (diameter) of 500 mm and a height of 300 mm as a base was defined as a ring H. The repetition distance on the circumference of the protrusions was 261.8 mm. FIG. 2H illustrates a schematic cross-sectional view of the ring H and the regulating unit.

### Example 9 of a Heat Treatment Zone Ring

A ring obtained by providing 360 triangle protrusions each having a height of 1.5 mm and a length of 200 mm at an equal interval to a cylindrical ring having an inner diameter (diameter) of 500 mm and a height of 300 mm as a base was defined as a ring I. The repetition distance on the circumference of the protrusions was 4.4 mm. FIG. 2I illustrates a schematic cross-sectional view of the ring I and the regulating unit.

### Example 10 of a Heat Treatment Zone Ring

A cylindrical ring without irregularities on an inner surface having an inner diameter (diameter) of 500 mm and a height of 300 mm was obtained and defined as a ring J. FIG. 2J illustrates a schematic cross-sectional view of the ring J and the regulating unit.

### Example 1

The toner treated particles A1 were heat-treated through use of the ring A illustrated in FIG. 2A as a heat treatment zone ring in the apparatus illustrated in FIGS. 1A and 1B. The inner diameter of the apparatus was set to a diameter of 500 mm, and a columnar member having an outer diameter of 300 mm was used as the regulating unit 6.

The toner treated particles A1 were heat-treated so as to have an average circularity of 0.970 through use of the apparatus with the construction.

The operation conditions at this time were as follows: hot air temperature: 160° C., hot air amount (2-port total): 27 m³/min, feed amount (2-port total): 100 kg/hr, raw material-conveying compressed gas amount (IJ) (2-port total): 3.5 m³/min, amount of a cold air 1 (upper 4-port total): 6 m³/min, amount of a cold air 2 (lower 4-port total): 2 m³/min, collection blower air amount: 50 m³/min, and operation time: 30 minutes.

The particle size distribution of the heat-treated toner particles obtained at this time was as follows: weight average particle diameter: 7.2 μm, proportion of particles each having a particle diameter of 4.0 μm or less: 15.5 number %, and proportion of particles (coarse powder) each having a particle diameter of at least 10.8 μm, which was 1.5 times as large as the weight average particle diameter: 4.9 vol %. Further, the frequency of particles each having a circularity of 0.990 or more in a circularity distribution was 14.6%, and the average circularity of the coarse powder having a particle diameter of 10.8 μm or more was 0.928. Table 1 shows the operation conditions.

The toner particles after heat treatment thus obtained were evaluated based on the following standards. Table 1 shows the evaluation results.

### Evaluation Standard 1

The amount (vol %) of a coarse powder in the toner particles after heat treatment was determined. An increase in amount of the coarse powder indicates that coalesced particles were generated, which is considered to indicate that particles provided with excess heat owing to the insufficient agitation in the toner layer and the insufficient mixing of hot air are present.

The toner particles after heat treatment were evaluated based on the following five stages. Levels A to C were defined as acceptable levels in the present invention.

A: The amount of the coarse powder is 5 vol % or less.
B: The amount of the coarse powder exceeds 5 vol % and is 10 vol % or less.
C: The amount of the coarse powder exceeds 10 vol % and is 15 vol % or less.
D: The amount of the coarse powder exceeds 15 vol % and is 20 vol % or less.
E: The amount of the coarse powder exceeds 20 vol %.

### Evaluation Standard 2

The average circularity of a coarse powder in toner particles after heat treatment was determined. In a conventional obtaining apparatus, spheroidization does not proceed easily because heat is not easily applied to a coarse powder rotating around the outer circumference in the layer. Further, the average circularity of the coarse powder tended to become lower than that of a raw material owing to the coalesced particles each having a low circularity. The high average circularity of the coarse powder is considered to indicate that heat is also applied to the coarse powder, the amount of coalesced particles is small, and heat is applied to the toner particles equally irrespective of their particle diameters.

The toner particles after heat treatment were evaluated based on the following five stages.

A: The average circularity of the coarse powder is 0.925 or more.
B: The average circularity of the coarse powder is 0.920 or more and less than 0.925.
C: The average circularity of the coarse powder is 0.915 or more and less than 0.920.
D: The average circularity of the coarse powder is 0.910 or more and less than 0.915.
E: The average circularity of the coarse powder is less than 0.910.

### Evaluation Standard 3

The frequency of particles each having a circularity of 0.990 or more in a circularity distribution of toner particles after heat treatment was determined. Even when the respective toner particles equally receive the same heat quantity, the circularity of a fine powder becomes larger easily. In the present invention, the powder particles are agitated and supplied with heat equally irrespective of their particle diameters, and hence the efficiency of thermal spheroidization is enhanced. Therefore, the total heat quantity to be applied for obtaining the same circularity can be reduced. When the number of particles each having a circularity of 0.990 or more is reduced even with the same average circularity, the reduction is considered to indicate that the efficiency of thermal spheroidization is high.

The toner particles after heat treatment were evaluated based on the following four stages.

A: The frequency of particles each having a circularity of 0.990 or more is 15% or less.
B: The frequency of particles each having a circularity of 0.990 or more is more than 15% and equal to or less than 20%.
C: The frequency of particles each having a circularity of 0.990 or more is more than 20% and equal to or less than 30%.
D: The frequency of particles each having a circularity of 0.990 or more is more than 30%.

### Examples 2 to 7, Comparative Examples 1 to 3

In the apparatus of FIGS. 1A and 1B, the rings B to J were each used as the heat treatment zone ring as shown in Table 1.

The hot air temperature was adjusted so that the average circularity was 0.970, and the toner treated particles A1 were heat-treated through use of the apparatus with the construction. Table 1 shows the operation conditions. Further, the toner particles after heat treatment were evaluated based on the same standards as those in Example 1. Table 1 shows the evaluation results.

Based on the evaluations of Examples 1 to 7, it was confirmed that the generation amount of a coarse powder was suppressed by providing irregularities on the inner wall surface of the apparatus. The reason for this is considered as follows: the particle size distribution of a toner layer was disturbed by the irregularities, and the generation of coalesced particles caused by excess melting of a fine powder was suppressed.

Further, the efficiency of heat treatment was enhanced, and hence, the temperature of hot air required to obtain the same average circularity decreased. It is preferred that the height or depth of each of the irregularities be 20 mm or more because the entire toner layer can be agitated. However, when the height or depth exceeds 30 mm to increase a change ratio of a gap, the rotating flow may be disturbed.

Examples 1 to 3 in which the interval of the irregularities is appropriate are preferred because heat can be further equally applied irrespective of the particle diameter of toner.

In Comparative Example 1, even when the temperature of hot air to be supplied was raised to 190° C. before operation, an average circularity of 0.970 could not be obtained. When the temperature of hot air was raised to more than 190° C., a fused substance was generated in the apparatus. The ratio of particles each having a circularity of 0.990 or more was large even through an average circularity was not increased. Thus, it is presumed that toner directed to the collection unit through a short path and toner remaining in the apparatus for a long period time are present. Probably, the protrusion was so large that the rotating flow in the apparatus was inhibited.

In Comparative Examples 2 and 3, the effects of the present invention were not obtained. For example, products similar to those of the apparatus of the present invention were able to be obtained in the case of an operation at a raw material supply amount of 50 kg/h or less; however, the generation amount of a coarse powder and the increase in particles each having a circularity of 0.990 or more could not be suppressed in the case of an operation at a raw material supply amount of 100 kg/h.

It was confirmed from the examples that toner particles which contained less coarse particles generated due to coalescence and which were heat-treated uniformly were able to be obtained with the apparatus for heat treatment of the present invention.

TABLE 1

| | | | | | | | | | Compar- | Compar- | Compar- |
|---|---|---|---|---|---|---|---|---|---|---|---|
| | | | | | | | | | ative | ative | ative |
| | | Example | Example | Example | Example | Example | Example | Example | Example | Example | Example |
| | | 1 | 2 | 3 | 4 | 5 | 6 | 7 | 1 | 2 | 3 |
| Apparatus | Heat treatment | A | B | C | D | E | F | G | H | I | J |
| condition | zone ring | | | | | | | | | | |
| | Height of | 25 | 20 | 10 | 35 | 5 | 45 | 2.5 | 60 | 1.5 | 0 |
| | protrusion (mm) | | | | | | | | | | |
| | Number of | 18 | 9 | 60 | 6 | 90 | 1 | 180 | 6 | 360 | 0 |
| | irregularities | | | | | | | | | | |
| | Repetition | 159-190 | 174.5 | 26.2 | 261.8 | 17.5 | (1570.8) | 8.7 | 261.8 | 4.4 | — |
| | distance of | | | | | | | | | | |
| | irregularities | | | | | | | | | | |
| | (mm) | | | | | | | | | | |
| | Dₘᵢₙ/ Dₘₐₓ | 0.762 | 0.80 | 0.90 | 0.65 | 0.952 | 0.55 | 0.975 | 0.40 | 0.985 | — |
| Operation | Raw material | 100 | 100 | 100 | 100 | 100 | 100 | 100 | 100 | 100 | 100 |
| condition | supply amount | | | | | | | | | | |
| | (kg/h) | | | | | | | | | | |
| | Temperature of | 160 | 160 | 165 | 160 | 170 | 165 | 170 | 190 | 180 | 180 |
| | hot air to be | | | | | | | | | | |
| | supplied (° C.) | | | | | | | | | | |
| Treated | Average | 0.970 | 0.970 | 0.970 | 0.970 | 0.970 | 0.970 | 0.970 | 0.962 | 0.970 | 0.970 |
| toner | circularity | | | | | | | | | | |
| measure- | D4 (μm) | 7.2 | 7.4 | 7.7 | 7.5 | 7.8 | 7.6 | 7.7 | 8.2 | 8.4 | 8.6 |
| ment | Amount of coarse | 4.9 | 6.5 | 12.1 | 8.7 | 13.5 | 9.2 | 11.8 | 18.2 | 24.6 | 28.9 |
| value | powder (vol %) | | | | | | | | | | |
| | Circularity | 0.928 | 0.923 | 0.926 | 0.918 | 0.922 | 0.923 | 0.912 | 0.908 | 0.905 | 0.904 |
| | limited to | | | | | | | | | | |
| | coarse powder | | | | | | | | | | |
| | Ratio of | 14.6 | 16.7 | 20.6 | 14.4 | 27.3 | 32.0 | 34.2 | 37.6 | 35.9 | 36.3 |
| | particles each | | | | | | | | | | |
| | having | | | | | | | | | | |
| | circularity of | | | | | | | | | | |
| | 0.990 or more | | | | | | | | | | |
| | (%) | | | | | | | | | | |
| Evaluation | Evaluation | A | B | C | B | C | B | C | D | E | E |
| result | standard 1 | | | | | | | | | | |
| | Evaluation | A | B | A | C | B | B | D | E | E | E |
| | standard 2 | | | | | | | | | | |
| | Evaluation | A | B | C | A | C | D | D | D | D | D |
| | standard 3 | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese

Patent Application No. 2011-130924, filed Jun. 13, 2011, which is hereby incorporated by reference herein in its entirety.

### REFERENCE SIGNS LIST

1 body of a heat treatment apparatus
2 hot air supply unit
3 powder particle supply unit
4 cold air supply unit
5 collection unit
6 regulating unit
7 heat treatment zone ring

1. A heat treatment apparatus for heat-treating powder particles each containing a binder resin and a colorant, the heat treatment apparatus comprising:
(1) a treatment chamber having a cylindrical shape, in which the powder particles are heat-treated;
(2) a powder particle supply unit for supplying the powder particles to the treatment chamber;
(3) a hot air supply unit for heat-treating the supplied powder particles;
(4) a cold air supply unit for cooling the heat-treated powder particles;
(5) a regulating unit for regulating a flow of the supplied powder particles, the unit being provided in the treatment chamber; and
(6) a collection unit for collecting the heat-treated powder particles from a discharge port provided on a lower end part side of the treatment chamber,
wherein:
the regulating unit comprises a columnar member having a substantially circular cross-section, the member being placed on a center pole of the treatment chamber to protrude from a lower end part to an upper end part of the treatment chamber;
the hot air supply unit is provided so that the hot air to be supplied is rotated along an inner wall of the treatment chamber;
the discharge port of the collection unit is provided in an outer circumferential portion of the treatment chamber to keep a rotation direction of the powder particles;
at least one protrusion with a height of 2 mm or more and 50 mm or less is provided in a region on a downstream side of the powder particle supply unit and on an upstream side of the cold air supply unit in at least one of an inner wall surface of the treatment chamber and an outer wall surface of the regulating unit; and
the heat treatment apparatus has a cross-section plane,
the cross-section plane
being perpendicular to a center axis of the treatment chamber, and situated at the region where said protrusion is provided, and Dmin and Dmax satisfy the following relation
0.50≦Dmin/Dmax<1.0
where,
Dmin represents a minimum value of the distance of a gap between the treatment chamber and the columnar member measured in the cross-section plane, and
Dmax represents a maximum value of the distance of a gap between the treatment chamber and the columnar member measured in the cross-section plane.

2. The heat treatment apparatus according to claim 1, wherein at least two protrusions are provided on the inner wall of the treatment chamber, and a distance in a circumferential direction between adjacent protrusions is 20 mm or more and 200 mm or less.

3. A method of obtaining toner, comprising heat-treating powder particles each containing a binder resin and a colorant through use of a heat treatment apparatus for obtaining the toner, wherein the heat treatment apparatus comprises the apparatus for heat treatment according to claim 1.
